(19) United States
(12) Patent Application Publication
(10) Pub. No.: US 2014/0267435 A1
(43) Pub. Date: Sep. 18, 2014

(54) IMAGE EDITING METHOD, MACHINE-READABLE STORAGE MEDIUM, AND TERMINAL

(71) Applicant: Samsung Electronics Co., Ltd., Gyeonggi-do (KR)

(72) Inventors: Ji-Hwan CHOE, Gyeonggi-do (KR); Seung-Joo CHOE, Seoul (KR); Sung-Dae CHO, Gyeonggi-do (KR)

(73) Assignee: Samsung Electronics Co., Ltd., Gyeonggi-do (KR)

(21) Appl. No.: 14/211,931

(22) Filed: Mar. 14, 2014

(30) Foreign Application Priority Data
Mar. 14, 2013 (KR) 10-2013-0027278

(51) Int. Cl. G06T 3/40

(52) U.S. Cl. CPC G06T 3/40
USPC 345/660

(57) ABSTRACT

An image editing method includes recognizing a subject in an input image and extracting information related to the recognized subject; identifying composition information corresponding to the extracted subject-related information in a composition database; configuring a composition area in the input image according to the identified composition information; and displaying an image corresponding to the composition area on a screen.

### PRIORITY

This application claims priority under 35 U.S.C. §119(a) to Korean Application Serial No. 10-2013-0027278, which was filed in the Korean Intellectual Property Office on Mar. 14, 2013, the entire content of which is incorporated herein by reference.

### BACKGROUND

1. Field of the Invention

The present invention generally relates to an image editing method, and more particularly, to a method of editing an image based on a composition of a subject.

2. Description of the Related Art

An electronic device directly controlled by a user includes at least one display device, and the user can control the electronic device through an input device while viewing various operation states or application operations of the electronic device through the display device. In particular, a portable terminal, such as a mobile phone, which can be carried by a user, is typically not equipped, due to its limited size, with a four directional button for operation of up-down and left-right movements. Instead, the portable terminal provides a user interface through an input device allowing a touch screen input by a user.

Further, a conventional mobile phone basically provides an application for photographing by a camera or editing an image stored in a storage unit, and a user can perform an image cropping by using such an application.

Also, for the image cropping, an application for automatically configuring a crop area has been already disclosed in the prior art. However, in the application, a crop area is configured without considering a composition of a subject, which may cause inconvenience to the user.

### SUMMARY

The present invention has been made to at least partially solve, reduce, or remove at least one of the problems and/or disadvantages described above, and to provide at least the advantages described below.

Accordingly, an aspect of the present invention is to provide a method by which a user can perform an image cropping in a more convenient and easier manner by a simple operation.

Another aspect of the present invention is to provide a method of automatically configuring a composition area in consideration of a composition of a subject, so as to enable a faster and more exact image cropping.

In accordance with an aspect of the present invention, an image editing method includes recognizing a subject in an input image and extracting information related to the recognized subject; identifying composition information corresponding to the extracted subject-related information in a composition database; configuring a composition area in the input image according to the identified composition information; and displaying an image corresponding to the composition area on a screen.

In accordance with another aspect of the present invention, a terminal providing an image editing function is provided. The terminal includes a display unit that displays a screen; a storage unit that stores a composition database; and a controller that recognizes a subject in an input image, extracts information related to the recognized subject, identifies composition information corresponding to the extracted subject-related information in a composition database, configures a composition area in the input image according to the identified composition information, and displays an image corresponding to the composition area on a screen.

In accordance with another aspect of the present invention, a non-transitory machine-readable recording medium having recorded thereon a program for executing an image editing method is provided. The method includes recognizing a subject in an input image and extracting information related to the recognized subject; identifying composition information corresponding to the extracted subject-related information in a composition database; configuring a composition area in the input image according to the identified composition information; and displaying an image corresponding to the composition area on a screen.

### BRIEF DESCRIPTION OF THE DRAWINGS

The above and other aspects, features, and advantages of the present invention will be more apparent from the following detailed description taken in conjunction with the accompanying drawings, in which:

FIG. 1 is a block diagram schematically illustrating a portable terminal according to an embodiment of the present invention;

FIG. 2 illustrates a front perspective view of a portable terminal according to an embodiment of the present invention;

FIG. 3 is a rear perspective view of a portable terminal according to an embodiment of the present invention;

FIG. 4 is a block diagram illustrating principal elements of a portable terminal for performing an image editing method;

FIG. 5 is a diagram for describing composition information;

FIG. 6 is a block diagram illustrating elements of an image analysis module in detail;

FIG. 7 is a flowchart illustrating an image editing method according to an exemplary embodiment of the present invention;

FIGS. 8A to 9B are diagrams illustrating image analysis and composition area configuration according to an embodiment of the present invention;

FIGS. 10A and 10B are diagrams for describing post processing of a composition area according to a first embodiment of the present invention;

FIGS. 11A and 11B are diagrams for describing post processing of a composition area according to a second embodiment of the present invention;

FIG. 12 is a diagram for describing a result of post processing according to an embodiment of the present invention;

FIG. 13 is a diagram for describing post processing of a composition area according to a third embodiment of the present invention; and

FIGS. 14A and 14B are diagrams for describing post processing of a composition area according to a fourth embodiment of the present invention.

### DETAILED DESCRIPTION OF EMBODIMENTS OF THE PRESENT INVENTION

The present invention may have various modifications and various embodiments, among which specific embodiments will now be described more fully with reference to the accompanying drawings. However, it should be understood that there is no intent to limit the present invention to the specific embodiments, but on the contrary, the present invention covers all modifications, equivalents, and alternatives falling within the scope of the invention.

Terms including ordinal numerals such as “first”, “second”, and the like can be used to describe various structural elements, but the structural elements are not limited by these terms. The terms are used only to distinguish one structural element from another structural element. For example, without departing from the scope of the present invention, a first structural element may be referred to as a second structural. Similarly, the second structural element also may be referred to as the first structural element. The terms “and/or” includes combinations of a plurality of related items or a certain item among the plurality of related items.

The terms used in this application are for the purpose of describing particular embodiments only and is not intended to limit the invention. As used herein, the singular forms are intended to include the plural forms as well, unless the context clearly indicates otherwise. In the description, it should be understood that the terms “include” or “have” indicate existence of a feature, a number, a step, an operation, a structural element, parts, or a combination thereof, and do not previously exclude the existence or probability of addition of one or more other features, numerals, steps, operations, structural elements, parts, or combinations thereof.

Unless defined differently, all terms used herein, which include technical terminologies or scientific terminologies, have the same meaning as a person skilled in the art to which the present invention belongs. Such terms as those defined in a generally used dictionary are to be interpreted to have meanings equal to the contextual meanings in the relevant field of art, and are not to be interpreted to have ideal or excessively formal meanings unless clearly defined in the present specification.

In the present invention, a terminal may be a device equipped with a touch screen, and may be referred to as a portable terminal, a mobile terminal, a communication terminal, a portable communication terminal, a portable mobile terminal, and so on.

For example, the terminal may be a smart phone, a portable phone, a game player, a Television (TV), a display unit, a heads-up display unit for a vehicle, a notebook computer, a laptop computer, a tablet Personal Computer (PC), a Personal Media Player (PMP), a Personal Digital Assistant (PDA), or the like. The terminal may be implemented as a portable communication terminal which has a wireless communication function and a pocket size. Also, the terminal may be a flexible device or a flexible display device.

A representative configuration of the terminal as described above corresponds to a configuration of a mobile phone, and some components of the representative configuration of the terminal may be omitted or changed if necessary.

FIG. 1 is a block diagram schematically illustrating a portable terminal according to an embodiment of the present invention.

Referring to FIG. 1, a portable terminal 100 can be connected with an external electronic device (not shown) by using one of a communication module 120, a connector 165, and an earphone connecting jack 167. The electronic device may include one of various devices such as an earphone, an external speaker, a Universal Serial Bus (USB) memory, a charger, a cradle/dock, a DMB antenna, a mobile payment related device, a health management device (blood sugar tester or the like), a game machine, a car navigation device and the like which can attached to the portable terminal 100 through a wire and removable from the portable terminal 100. Further, the electronic device may include a Bluetooth communication unit, a Near Field Communication (NFC) unit, a WiFi Direct communication unit and a wireless Access Point (AP). In addition, the portable terminal 100 can be connected with another portable terminal or an electronic device, for example, one of a mobile phone, a smart phone, a tablet PC, a desktop PC, and a server.

Referring to FIG. 1, the portable terminal 100 includes at least one touch screen 190 and at least one touch screen controller 195. Further, the portable terminal 100 includes a controller 110, a communication module 120, a multimedia module 140, a camera module 150, an input/output module 160, a sensor module 170, a storage unit 175, and a power supply unit 180.

The communication module 120 includes a mobile communication module 121, a sub communication module 130, and a broadcast communication module 141.

The sub-communication module 130 includes at least one of a wireless LAN module 131 and a short range communication module 132, and the multimedia module 140 includes at least one of an audio reproduction module 142 and a video reproduction module 143. The camera module 150 includes at least one of a first camera 151 and a second camera 152. Further, the camera module 150 includes at least one of a barrel 155 for zooming in/zooming out the first and/or second cameras 151 and 152, a motor 154 for controlling a zooming in/zooming out motion of the barrel 155, and a flash 153 for providing a light source for photographing according to a main purpose of the portable terminal 100. The input/output module 160 includes at least one of a button 161, a microphone 162, a speaker 163, a vibrator 164, a connector 165, a keypad 166, an earphone connecting jack 167, an input unit 168, and an attachment/detachment recognition switch 169.

The controller 110 includes a CPU 111, a ROM 112 storing a control program for controlling the portable terminal 100, and a RAM 113 used as a storage area for storing a signal or data input from the outside of the portable terminal 100 or for work performed in the portable terminal 100. The CPU 111 may include a single core, a dual core, a triple core, or a quad core. The CPU 111, the ROM 112, and the RAM 113 may be mutually connected to one another through an internal bus.

The controller 110 controls the communication module 120, the multimedia module 140, the camera module 150, the input/output module 160, the sensor module 170, the storage unit 175, the power supply unit 180, the touch screen 190, and the touch screen controller 195.

The controller 110 detects a user input at input unit 168 or a touchable user input means such as a user's finger which touches or approaches one object or is located close to the object in a state where a plurality of objects or items are displayed on the touch screen 190, and identifies an object corresponding to a position of the touch screen 190 where the user input is generated. The user input through the touch screen 190 includes one of a direct touch input of directly touching the object and a hovering input which is an indirect touch input of approaching the object within a preset recognition range, but not directly touching the object. For example, when the input unit 168 is located close to the touch screen 190, an object located directly under the input unit 168 may be selected. According to the present invention, user inputs include a gesture input through the camera module 150, a switch/button input through the button 161 or the keypad 166, a voice input through the microphone 162, or the like, as well as the user input through the touch screen 190.

The object or item (or function item) is displayed on the touch screen 190 of the portable terminal 100. For example, the object or item indicates at least one of an application, a menu, a document, a widget, a picture, a video, an e-mail, an SMS message, and an MMS message, and can be selected, executed, deleted, canceled, stored, and changed by a user input means. The item can be used as a button, an icon (or short-cut icon), a thumbnail image, or a folder storing at least one object in the portable terminal. Further, the item may be displayed in the form of an image, a text or the like.

The short-cut icon is an image displayed on the touch screen 190 of the portable terminal 100 to rapidly execute each application or operation, for example, a phone communication, a contact number, a menu, or the like basically provided in the portable terminal 100. When a command or selection for executing the application or the operation is input, the short-cut icon executes the corresponding application.

Further, the controller 110 detects a user input such as a hovering event as the input unit 168 approaches the touch screen 190 or is located close to the touch screen 190.

The controller 110 outputs a control signal to the input unit 168 or the vibrator 164. The control signal includes information on a vibration pattern, and the input unit 168 or the vibrator 164 generates a vibration according to the vibration pattern. The information on the vibration pattern may indicate the vibration pattern itself, an indicator of the vibration pattern, or the like. Alternatively, the control signal may include only a request for generating the vibration.

The portable terminal 100 includes at least one of the mobile communication module 121, the wireless LAN module 131, and the short distance communication module 132 according to a capability thereof.

The mobile communication module 121 enables the portable terminal 100 to be connected with the external device through mobile communication by using one antenna or a plurality of antennas according to a control of the controller 110. The mobile communication module 121 transmits/receives a wireless signal for voice phone communication, video phone communication, a Short Message Service (SMS), or a Multimedia Message Service (MMS) to/from a mobile phone, a smart phone, a tablet PC, or another device having a phone number input into the portable device 100.

The sub-communication module 130 includes at least one of the wireless LAN module 131 and the short range communication module 132. For example, the sub-communication module 130 may include only the wireless LAN module 131, only the short range communication module 132, or both the wireless LAN module 131 and the short range communication module 132.

The wireless LAN module 131 may be connected to the Internet in a place where a wireless Access Point (AP) is installed, under a control of the controller 110. The wireless LAN module 131 supports a wireless LAN standard (IEEE802.11x) of the Institute of Electrical and Electronics Engineers (IEEE). The short distance communication module 132 can wirelessly perform NFC between the portable terminal 100 and an image forming apparatus according to a control of the controller 110. The short-range communication scheme may include a Bluetooth communication scheme, an Infrared Data Association (IrDA) scheme, a Wi-Fi Direct communication scheme, a Near Field Communication (NFC) scheme, or the like.

The controller 110 can transmit a control signal according to a vibration pattern to the input unit 168 through the sub communication module 130.

The broadcasting and communication module 141 receives a broadcasting signal (for example, a TV broadcasting signal, a radio broadcasting signal, or a data broadcasting signal) and broadcasting supplement information (for example, Electronic Program Guide (EPG) or Electronic Service Guide (ESG)) output from a broadcasting station through a broadcasting and communication antenna, under a control of the controller 110.

The multimedia module 140 includes the audio reproduction module 142 or the video reproduction module 143. The audio reproduction module 142 reproduces a digital audio file (for example, a file having a file extension of mp3, wma, ogg, or way) which is stored or received in the storage unit 175, under a control of the controller 110. The video reproduction module 143 reproduces a digital video file (for example, a file having a file extension of mpeg, mpg, mp4, avi, mov, or mkv) stored or received, under a control of the controller 110. The video reproduction module 143 reproduces the digital audio file. The multimedia module 140 may be integrated in the controller 110.

The camera module 150 includes at least one of the first camera 151 and the second camera 152 for photographing a still image or a video, under a control of the controller 110. Further, the camera module 150 includes at least one of the barrel 155 performing a zoom-in/out for photographing the subject, the motor 154 controlling a motion of the barrel 155, and the flash 153 providing an auxiliary light required for photographing the subject. The first camera 151 may be disposed on a front surface of the apparatus 100, and the second camera 152 may be disposed on a back surface of the apparatus 100.

Each of the first and second cameras 151 and 152 includes a lens system, an image sensor, or the like. Each of the first and second cameras 151 and 152 converts an optical signal input (or photographed) through the lens system to an electrical image signal (or a digital image) and outputs the converted electrical image signal to the controller 110. Then, the user photographs a video or a still image through the first and second cameras 151 and 152.

The input/output module 160 includes at least one among one or more buttons 161, one or more microphones 162, one or more speakers 162, one or more vibrators 164, a connector 165, a keypad 166, an earphone connecting jack 167, and an input unit 168. The input/output module 160 is not limited thereto, and a mouse, a trackball, a joystick, or a cursor control such as cursor direction keys may be provided for controlling a motion of a cursor on the input device 190.

The button 161 may be formed on a front surface, a side surface, or a back surface the housing of the portable terminal 100, and includes at least one of a power/lock button, a volume button, a menu button, a home button, a back button, and a search button.

The microphone 162 receives a voice or a sound to generate an electrical signal according to a control of the controller 110.

The speaker 163 can output sounds corresponding to various signals or data (for example, wireless data, broadcasting data, digital audio data, digital video data, or the like) to the outside of the portable terminal 100 according to a control of the controller 110. The speaker 163 outputs a sound (for example, button tone corresponding to phone communication, ringing tone, and a voice of another user) corresponding to a function performed by the portable terminal 100. One speaker 163 or a plurality of speakers 163 may be formed on a suitable position or positions of the housing of the portable terminal 100.

The vibrator 164 converts an electrical signal to a mechanical vibration under a control of the controller 110. For example, when the a portable terminal 100 in a vibration mode receives a voice or video call from another device (not shown), the vibrator 164 is operated. One vibrator 164 or a plurality of vibrators 164 may be formed within the housing of the portable terminal 100. The vibrator 164 can operate in correspondence to a user input through the touch screen 190.

The connector 165 may be used as an interface for connecting the portable terminal 100 with an external electronic device or a power source (not shown). The controller 110 transmits or receive data stored in the storage unit 175 of the portable terminal 100 to or from an external electronic device through a wired cable connected to the connector 165. The portable terminal 100 receives power from the power source through the wired cable connected to the connector 165 or charge a battery by using the power source.

The keypad 166 receives a key input from a user for the control of the portable terminal 100. The keypad 166 includes a physical keypad formed in the portable terminal 100 or a virtual keypad displayed on the display unit 190. The physical keypad formed in the portable terminal 100 may be excluded according to a capability or structure of the portable terminal 100.

An earphone may be inserted into the earphone connecting jack 167 to be connected with the electronic device 100.

The input unit 168 may be inserted into the inside of the portable terminal 10 and withdrawn or separated from the portable terminal 100 when being used. An attachment/detachment recognition switch 169 which works in accordance with an installation and attachment/detachment of the input unit 168 is located in one area within the portable terminal 100 into which the input unit 168 is inserted, and the attachment/detachment recognition switch 169 can output signals corresponding to the installation and separation of the input unit 168 to the controller 110. The attachment/detachment recognition switch 169 may be configured to directly/indirectly contact the input unit 168 when the input unit 168 is mounted. Accordingly, the attachment/detachment recognition switch 169 generates a signal corresponding to the attachment or the detachment (that is, a signal notifying of the attachment or the detachment of the input unit 168) based on whether the attachment/detachment recognition switch 169 is connected with the input unit 168 and then outputs the generated signal to the controller 110.

The sensor module 170 includes at least one sensor for detecting a state of the portable terminal 100. For example, the sensor module 170 includes at least one of a proximity sensor for detecting whether the user approaches the portable terminal 100, an illumination sensor for detecting an amount of ambient light of the portable terminal 100, a motion sensor for detecting a motion (for example, rotation, acceleration, or vibration of the portable terminal 100) of the portable terminal 100, a geo-magnetic sensor for detecting a point of the compass by using the Earth's magnetic field, a gravity sensor for detecting a gravity action direction, an altimeter for measuring an atmospheric pressure to detect an altitude, and a GPS module 157.

Further, the sensor module 170 includes a first distance/biological sensor and a second distance/biological sensor.

The first distance/biological sensor is disposed at a front surface of a portable terminal and includes a first infrared light source and a first infrared light camera. The first infrared light source outputs an infrared light and the first infrared light camera detects an infrared light reflected by a subject. For example, the first infrared light source may include an LED array of a matrix structure.

For example, the first infrared light camera includes a filter that allows passage of an infrared light while blocking light in a wavelength band other than that of the infrared light, a lens system that focuses the infrared light having passed the filter, and an image sensor that converts an optical image formed by the lens system to an electric image signal. For example, the image sensor may include a PD array of a matrix structure.

The second distance/biological sensor is disposed at a rear surface of a portable terminal, has the same construction as that of the first distance/biological sensor, and includes a second infrared light source and a second infrared light camera.

The GPS module 157 receives radio waves from a plurality of GPS satellites in the Earth's orbit and calculates a position of the portable device 100 by using Time of Arrival from the GPS satellites to the portable device 100.

The storage unit 175 stores signals or data which are input/output corresponding to operations of the mobile communication module 120, the multimedia module 140, the camera module 150, the input/output module 160, the sensor module 170, and the touch screen 190, under a control of the controller 110. The storage unit 175 stores a control program and applications for controlling the portable terminal 100 or the controller 110

The term “storage unit” is used as a term which refers to a random data storage device such as the storage unit 175, the ROM 112 or the RAM 113 within the controller 110, or a memory card (for example, an SD card or a memory stick) installed in the portable terminal 100. The storage unit 175 may include a non-volatile memory, a volatile memory, or a Hard Disk Drive (HDD) or a Solid State Drive (SSD).

Further, the storage unit 175 stores various applications such as a navigation, video calls, games, time-based alert applications, or the like; images to provide a Graphical User Interface (GUI) related to the applications; databases or data related to user information, documents or an image editing method; background images (e.g., a menu screen, an idle screen, etc.) for processing data and operating the portable device 100; operating programs; and images photographed by the camera.

Furthermore, the storage unit 175 stores a program and related data for executing a situation recognition-based screen scroll method according to the present invention.

The storage unit 175 is a machine (for example, computer)-readable medium, and the phrase “machine-readable medium” may be defined as a medium for providing data to the machine so that the machine performs a specific function. The storage unit 175 may include a non-volatile medium and a volatile medium. All of these media should be a type that allows the commands transferred by the media to be detected by a physical instrument in which the machine reads the commands into the physical instrument.

The computer readable storage medium includes, but is not limited to, at least one of a floppy disk, a flexible disk, a hard disks, a magnetic tape, a Compact Disc Read-Only Memory (CD-ROM), an optical disk, a punch card, a paper tape, a RAM, a Programmable Read-Only Memory (PROM), an Erasable PROM (EPROM), and a Flash-EPROM. The computer readable storage medium includes, but is not limited to, at least one of a floppy disk, a flexible disk, a hard disks, a magnetic tape, a Compact Disc Read-Only Memory (CD-ROM), an optical disk, a punch card, a paper tape, a RAM, a Programmable Read-Only Memory (PROM), an Erasable PROM (EPROM), and a Flash-EPROM. PROM).

The power supply unit 180 supplies power to one battery or a plurality of batteries arranged at the housing of the portable terminal 100 according to a control of the controller 110. The one battery or the plurality of batteries supplies power to the portable terminal 100. Further, the power supply unit 180 supplies power input from an external power source through a wired cable connected to the connector 165 to the portable terminal 100. In addition, the power supply unit 180 supplies power wirelessly input from the external power source through a wireless charging technology to the portable terminal 100.

The portable terminal 100 includes at least one touch screen 190 providing user graphical interfaces corresponding to various services (for example, a phone call, data transmission, broadcasting, and photography) to the user.

The touch screen 190 outputs an analog signal corresponding to at least one user input which is input into the user graphical interface, to the touch screen controller 195.

The touch screen 190 receives at least one user input through a user's body, i.e. a finger, or the input unit 168, i.e. a stylus pen, an electronic pen, or the like.

The touch screen 190 receives successive motions of one touch (that is, a drag input). The touch screen 190 outputs an analog signal corresponding to the successive motions of the input touch to the touch screen controller 195.

The term “touch” used in the present invention is not limited to a contact between the touch screen 190 and the finger or input unit 168, and may include a noncontact input (for example, a case where the user input means is located within a recognition distance (for example, 1 cm) where the user input means can be detected without a direct contact).

A distance or interval within which the user input means can be recognized in the touch screen 190 may be changed according to a capacity or structure of the portable terminal 100. Particularly, the touch screen 190 is configured to output different values (for example, including a voltage value or a current value as an analog value) detected by a direct touch event and a hovering event so that the direct touch event by a contact with the user input means and the noncontact touch event (that is, the hovering event) can be distinguishably detected.

The touch screen 190 may be implemented in, for example, a resistive type, a capacitive type, an infrared type, an acoustic wave type or a combination thereof

Further, the touch screen 190 may include at least two touch screen panels capable of detecting a finger input and a pen input, respectively, in order to distinguish an input, i.e. a finger input, by a passive type of a first user input means, and an input, i.e. a pen input, by an input unit 168 which is an active type of a second user input means. With the user input means, a classification of a passive type and an active type can be achieved according to whether energy such as electronic waves, electromagnetic waves, or the like are generated or induced. The two or more touch panels provide different output values to the touch screen controller 195. Then, the touch screen controller 195 can recognize the different values input to the two or more touch panels to distinguish whether the input from the touch screen 190 is an input by the finger or an input by the input unit 168. For example, the touch screen 190 may be a combination of a capacitive type touch screen panel and an electromagnetic resonance type touch screen panel. Further, as described above, the touch screen 190 may include touch keys such as the menu button 161b, the back button 161c and like, and accordingly, a finger input or a finger input on the touch screen 190 includes a touch input on the touch key.

The touch screen controller 195 converts an analog signal received from the touch screen 190 to a digital signal, and transmits the converted digital signal to the controller 110. The controller 110 controls the touch screen 190 by using the digital signal received from the touch screen controller 195. For example, the controller 110 allows a short-cut icon or an object displayed on the touch screen 190 to be selected or executed in response to the direct touch event or the hovering event. Further, the touch screen controller 195 may be integrated with the controller 110.

The touch screen controller 195 determines a position of a user input and a hovering interval or distance by detecting a value (for example, a current value, or the like) output through the touch screen 190, converts the determined distance value into a digital signal (for example, Z coordinates), and provides the digital signal to the controller 110. Further, the touch screen controller 190 detects a pressure applied to the touch screen 190 by the user input means by detecting the value (for example, the current value or the like) output through the touch screen 190, converts the identified pressure value to a digital signal, and then provides the converted digital signal to the controller 110.

FIG. 2 illustrates a front perspective view of the portable terminal, and FIG. 3 illustrates a rear perspective view of the portable terminal according to an embodiment of the present invention.

Referring to FIGS. 2 and 3, the touch screen 190 is disposed on a center of a front surface 101 of the portable terminal 100. The touch screen 190 can have a large size to occupy most of the front surface 101 of the portable terminal 100. FIG. 2 shows an example where a main home screen is displayed on the touch screen 190. The main home screen is a first screen displayed on the touch screen 190 when power of the portable terminal 100 is turned on. Further, when portable terminal 100 has different home screens of several pages, the main home screen may be a first home screen of the home screens of several pages. Short-cut icons 191-1, 191-2, and 191-3 for executing frequently used applications, an application (app) key 191-4, time, weather, or the like may be displayed on the home screen. When the user selects the app key 191-4, an app menu screen is displayed on the touch screen 190. Further, a status bar 192 which displays the status of the portable terminal 100 such as a battery charging status, a received signal intensity, and a current time may be formed on an upper end of the touch screen 190.

The touch keys such as the home button 161a, the menu button 161b, the back button 161c, or the like, mechanical keys, or a combination thereof may be arranged at a lower portion of the touch screen 190. Further, the touch keys may be constituted as a part of the touch screen 190.

The home button 161a displays the main home screen on the touch screen 190. For example, when the home button 161a is selected in a state where a home screen different from the main home screen or the menu screen is displayed on the touch screen 190, the main home screen is displayed on the touch screen 190. Further, when the home button 161a is selected while applications are executed on the touch screen 190, the main home screen shown in FIG. 2 may be displayed on the touch screen 190. In addition, the home button 161a may be used to display recently used applications or a task manager on the touch screen 190.

The menu button 161b provides a connection menu which can be displayed on the touch screen 190. The connection menu includes a widget addition menu, a background changing menu, a search menu, an editing menu, an environment setup menu, or the like.

The back button 161c may be used for displaying the screen which was executed just before the currently executed screen or terminating the most recently used application.

The portable terminal 100 has the first camera 151, the illuminance sensor 170a, the proximity sensor 170b, and the first distance/biological sensor, arranged on an upper side of the front surface 101 thereof. The second camera 152, the flash 153, the speaker 163, and the second distance/biological sensor are disposed on a rear surface 103 of the portable terminal 100.

For example, a power/reset button 161d, volume buttons 161e having a volume increase button 161f and a volume decrease button 161g, a terrestrial DMB antenna 141a for broadcasting reception, and one or a plurality of microphones 162 are disposed on a side surface 102 of the portable terminal 100. The DMB antenna 141a may be fixed to the portable terminal 100 or may be formed to be detachable from the portable terminal 100.

Further, the portable terminal 100 has the connector 165 arranged on a side surface of a lower end thereof. A plurality of electrodes is formed in the connector 165, and the connector 165 may be connected to an external device by a wire. The earphone jack 167 may be formed on a side surface of an upper end of the portable terminal 100. An earphone may be inserted into the earphone connecting jack 167.

Further, the input unit 168 may be mounted to a side surface of a lower end of the portable terminal 100. The input unit 168 can be inserted into the portable terminal 100 to be stored in the portable terminal 100, and withdrawn and separated from the portable terminal 100 when it is used.

FIG. 4 is a block diagram illustrating principal elements of a portable terminal for performing an image editing method.

The principle elements of the portable terminal include a camera module 150, a storage unit 175, a controller 110, and a touch screen 190.

The camera module 150 photographs the surrounding environment of the portable terminal 100 and outputs the photographed image to the controller 110.

The storage unit 175 includes an image storage unit 210 storing at least one image, a target database 212 storing data or information on a subject to be recognized, and a composition database 214 storing data or image required for image cropping.

The image storage unit 210 stores image files having image information, such as a photograph or drawing. The image files have various formats and extensions, representatives of which include, for example, BMP (*.BMP, *.RLE), JPEG (*.JPG), Compuserve GIF (*.GIF), PNG (*.PNG), Photoshop (*,PSD, *.PDD), TIFF (*.TIF), Acrobat PDF (*.PDF), RAW (*.RAW), Illustrator (*.AI), Illustrator, Photoshop EPS (*.EPS), Amiga IFF (*.IFF), FlaschPix (*.FPX), Filmstrip (*.FRM), PCX (*.PCX), PICT File (*.PCT, *.PIC), Pixar (*.PXR), Scitex (*.SCT), and Targa (*.TGA, *.VDA, *.ICB, *.VST).

Data on a subject stored in the target database 212 include a subject image, and/or information on a feature point (which may be also referred to as feature image or feature pattern) of the subject image. The feature point may be an edge, a corner, an image pattern, or a contour line.

The composition database 214 stores multiple pieces of composition information, and each piece of composition information may include type information of a subject, resolution or size information of an image, information on a location, an intensity, a size, and a direction of a subject, and/or information on a composition area. The multiple pieces of composition information may be also referred to as a plurality of records. Further, each composition information may include information on a plurality of subjects and the information on a location, a size, and/or a direction of a subject corresponds to a composition of the subject.

The type information of a subject may be a saliency (i.e., the most noticeable area of an image), an object, a body, a face, or a line.

The resolution or size information of an image includes a resolution of an image, an aspect ratio (i.e., width:height), and/or a width/height size. For example, the aspect ratio may be 4:3, 3:4, 16:9, or 9:16.

The information on a location of a subject includes a location of a representative point (e.g. central point) of the subject or locations of corner points defining the subject. The location may be expressed by coordinates or a ratio (e.g. a point corresponding to ⅓ of the entire width from the left end of an image or a point corresponding to ⅓ of the entire height from the upper end of an image).

The size information of a subject may be expressed by constant values, coordinates (coordinates of corner points), or a ratio (e.g. a point corresponding to ⅓ of the entire width from the left end of an image or a point corresponding to ⅓ of the entire height from the upper end of an image).

The information on a direction of a subject indicates a pose, an azimuth, or a direction, and corresponds to, for example, information on a direction in which the subject is oriented. The information on a direction of a subject may be expressed by five directions including a frontward direction, a leftward direction, a rightward direction, an upward direction, and a downward direction, or nine directions including a frontward direction, a leftward direction, a rightward direction, an upward direction, a downward direction, a left-upward direction, a left-downward direction, a right-upward direction, and a right-downward direction, or a vector in a two dimensional coordinate system or a three dimensional Cartesian coordinate system.

The information on an intensity of a subject indicates the degree by which the subject is prominent in comparison with its surrounding, and indicates a contrast (e.g. color difference, brightness difference, etc.), a thickness of a contour line or an edge, etc.

The composition information indicates a location and a size of a composition area and may indicate, for example, coordinates of corner points defining a composition area, coordinates of a central point of a composition area, a width/height of a composition area, etc.

As noted from Table 1 below, the composition database 214 may store multiple pieces of composition information in the form of a plurality of records.

TABLE 1

| | | | Subject | | | Composition |
|---|---|---|---|---|---|---|
| Record | Subject | Image | location/ | Subject | Subject | area |
| Number | type | resolution | size | direction | intensity | location/size |
| A1 | B1 | C1 | D1 | E1 | F1 | G1 |
| A2 | B2 | C2 | D2 | E2 | F2 | G2 |
| . . . | . . . | . . . | . . . | . . . | . . . | . . . |
| An | Bn | Cn | Dn | En | Fn | Gn |

Each record Ai (1≦i≦n, wherein n is an integer greater than or equal to 1) includes fields of subject type Bi, image resolution Ci, subject location/size Di, subject direction Ei, subject intensity Fi, and composition area location/size Gi. The subject location/size Di may be expressed by coordinates of diagonal corner points defining the subject, a location of a center of the subject, and a size of the subject. The composition area location/size Gi may be expressed by coordinates of diagonal corner points defining the composition area, a location of a center of the composition area, and a size of the composition area. Each field may have one value or a plurality of values and each value may be a constant, coordinates, a vector, or a matrix.

FIG. 5 is a diagram for describing composition information. In the present embodiment, a subject 320 corresponds to a face of a user.

In the present embodiment, the composition information includes an aspect ratio of an image 310 including the subject 320 (i.e. size information of the image), coordinates of diagonal corner points 332 and 334 of a virtual quadrilateral 330 defining the subject 320 (i.e. location information of the subject), an area of the virtual quadrilateral 330 (i.e. size information of the subject 320), direction information of the subject 320 (a frontward direction in the present embodiment), intensity information of the subject 320 (e.g. difference between the skin color and the background color or difference of brightness between the subject and the background), and coordinates of diagonal corners 342 and 344 or 352 and 354 of at least one composition area 340 or 350 (i.e. information on the composition area).

In the present embodiment, a first composition area 340 and a second composition area 350 are set for selection of a composition area for the same image and the same subject. The composition area is set based on information on an image and information on a subject. When a plurality of composition areas are set for selection of one composition area for the same image and the same subject, a user can select one of the plurality of composition areas.

Referring again to FIG. 4, the controller 110 includes an image analysis module (recognition engine) 220, a crop processing module 230, and a post processing module 240. The image analysis module 220 recognizes a subject from an image photographed by the camera module 150 or an image stored in the image storage unit 210 of the storage unit 175. The image analysis module 220 recognizes a subject within an input image through a recognition algorithm according to the type of the subject. Further, the image analysis module 220 can recognize which location the subject is positioned at and which direction the subject is oriented in (i.e. the location and pose of the subject).

The image analysis module 220 can use algorithms, such as Scale Invariant Feature Transform (SIFT) and Speeded Up Robust Features (SURF), to recognize a subject registered in the image storage unit 210 in the input image and can apply a template-based matching method to a recognized subject to estimate the pose.

The SIFT algorithm is disclosed in “Lowe, David G. (1999), “Object Recognition From Local Scale-Invariant Features”, Proceedings of the International Conference on Computer Vision. 2. pp. 11501157. doi:10.1109/ICCV.1999.790410″. The SURF algorithm is disclosed in “Bay, H., Tuytelaars, T., Gool, L. V., “SURF: Speeded Up Robust Features”, Proceedings of the Ninth European Conference on Computer Vision, May 2006”, and a method of estimating a pose by using a template-based matching method is disclosed in “Daniel Wagner, Gerhard Reitmayr, Alessandro Mulloni, Tom Drummond, Dieter Schmalstieg, “Real Time Detection and Tracking for Augmented Reality on Mobile Phones,” Visualization and Computer Graphics, August 2009”. The image analysis module 220 can recognize a subject registered in the target database 212 from an input image and estimate a pose of the subject based on two-dimensional (2D) or three-dimensional (3D) subject information stored in the target database 212.

The image analysis module 220 recognizes a subject in the input image and extracts information relating to the recognized subject. The image analysis module 220 may refer to the target database 212 for the recognition, and the image analysis module 220 recognizes an image area matching with a subject registered in the target database 212 in the input image. Further, according to the type of the subject to be recognized, the image analysis module 220 may recognize the subject without referring to the target database 212. For example, the image analysis module 220 may detect edge feature points and corner feature points in an input image and recognize a planar subject, such as a quadrilateral, a circle, or a polygon, defined by the edge feature points and corner feature points.

In order to recognize various types of subjects, the image analysis module 220 may include a plurality of engines.

FIG. 6 is a block diagram illustrating elements of an image analysis module 220 in greater detail.

The image analysis module 220 includes a saliency recognition engine 410, an object recognition engine 420, a body recognition engine 430, a face recognition engine 440, a line recognition engine 450, an object pose estimation engine 460, a body pose estimation engine 470, and a head pose estimation engine 480. That is, the image analysis module 220 is divided into separate engines according to types of subjects.

The saliency recognition engine 410 recognizes a saliency (i.e., the most noticeable area of an image) and outputs a location and/or an intensity of the saliency. The saliency recognition engine 410 uses a usual saliency map model to recognize an area showing a big color difference, an area showing a brightness color difference, or an area showing a contour line property in an input image as a saliency. The saliency recognition engine 410 recognizes a human being, a living thing, or an object, which is prominent in comparison with the background.

The object recognition engine 420 recognizes a living thing or an object other than a human body in an input image. The object recognition engine 420 may be divided into a 2D object recognition engine and a 3D object recognition engine. The 2D object recognition engine recognizes a 2D subject, such as a photograph, a poster, a book cover, a map, a marker, an Optical Character Reader (OCR), or a Quick Response (QR) code, in an input image. The 2D object recognition engine may be divided into separate recognition engines according to types of 2D subjects, such as a 2D image recognition engine, a 2D marker engine, an OCR recognition engine, and a QR code recognition engine. The 3D object recognition engine recognizes a three dimensional subject, such as a shoe, a mobile phone, a television (TV), or a picture frame, which corresponds to a living thing or an object other than a human body, in an input image.

The body recognition engine 430 can be incorporated into the 3D object recognition engine. Similar to the 2D object recognition engine, the 3D object recognition engine can be divided into separate recognition engines according to types of three dimensional subjects. The body recognition engine 430 recognizes a part of a body, such as a hand, excepting the face, or the entire body. The body recognition may be performed in the same or similar manner as the face recognition.

The face recognition engine 440 recognizes a face in an input image. The face recognition is performed using a usual face recognition method, for which a contour line of a face stored in the target database 212 of FIG. 4, a color and/or texture of the face skin, or a face recognition technique using a template may be used. For example, the face recognition engine 440 performs a face study through face images of a plurality of users and recognizes a face in an input image based on the face study. The face study information is stored in the target database 212.

The line recognition engine 450 detects edge feature points and corner feature points in an input image and recognizes a planar subject, such as a quadrilateral, a circle, or a polygon, defined by the edge feature points and corner feature points.

The object pose estimation engine 460 estimates a pose of a living thing or an object, other than a human body, recognized by the object recognition engine 420. The object pose estimation engine 460 may be incorporated into the object recognition engine 420.

The body pose estimation engine 470 estimates a pose of a part of a human body except for a face, or the entire body, recognized by the body recognition engine 430. The body pose estimation engine 470 may be incorporated into the body recognition engine 430.

The head pose estimation engine 480 estimates a pose of a face by the face recognition engine 440. The head pose estimation engine 480 may be incorporated into the face recognition engine 440.

Further, the face recognition engine 440, the body pose estimation engine 470, and the head pose estimation engine 480 may be incorporated into the body recognition engine 430, and the saliency recognition engine 410, the line recognition engine 450, and the object pose estimation engine 460 may be incorporated into the object recognition engine 420.

Referring again to FIG. 4, the crop processing module 230 receives recognized subject related information from the image analysis module 220 and searches for and identifies composition information matching with or corresponding to the subject related information in the composition database 214. The crop processing module 230 configures a composition area in an input image according to the identified composition information and outputs composition area configuration information to the post processing module 240. The composition area configuration information indicates a location and a size of a composition area.

The post processing module 240 modifies the composition area configured by the crop processing module 230 based on the subject related information, such as location information of the recognized subject and/or pose information of the recognized subject, and crops and outputs the input image according to the modified composition area or simply outputs an image in which the modified composition area is marked. The cropped image or the image with the marked composition area is displayed on a screen of the touch screen 190.

For example, the post processing module 240 determines whether an input image including a plurality of subjects includes a subject cut by a composition area configured by the crop processing module 230, and may modify or reconfigure the composition area to prevent the subject from being cut. Otherwise, the post processing module 240 determines whether an input image including a plurality of subjects includes a subject which does not belong to a composition area configured by the crop processing module 230, and may modify or reconfigure the composition area to make the subject belong to the composition area. Otherwise, the post processing module 240 may reconfigure or modify the composition area configured by the crop processing module 230 based on the direction information of the subject. The post processing module 240 may be incorporated into the crop processing module 230 and the crop processing module 230 may perform the functions of the post processing module 240.

FIG. 7 is a flowchart illustrating an image editing method according to an embodiment of the present invention.

In the image receiving step S110, the image analysis module 220 receives an image from the camera module 150 or the storage unit 175.

In the image analysis step S120, the image analysis module 220 recognizes a subject in the input image and extracts information relating to the recognized subject. The image analysis module 220 detects the location of the subject. Further, the image analysis module 220 may further detect the size of the subject, and may further detect the pose or direction of the subject. The image analysis module 220 recognizes the subject by referring to the target database 212 storing data or based information on the subject to be recognized.

In the database search step S130, the crop processing module 230 receives recognized subject related information from the image analysis module 220 and searches for and identifies composition information matching with the subject related information in the composition database 214. Further, the crop processing module 230 configures a composition area in the input image according to the identified composition information.

The crop processing module 230 receives subject related information from the image analysis module 220, and compares the subject related information with the composition information, i.e. records, stored in the composition database 214 to find a most similar record. In order to find a most similar record, various methods can be used.

When the subject is a face, for example, various methods as follows can be used.

First Method

First, when the location, size, and direction of a face recognized in an input image have values, x, y, and z, respectively, a difference aⱼ between the subject related information and the j-th record in which the type of the subject is a face is obtained by the following Equation (1). In the following Equation (1), each value may be a constant, a vector, or a matrix.

aⱼ=fⱼ(x,y,z) (1)

Second, fⱼ can be expressed by a weighted sum as in Equation (2).

fⱼ(x,y,z)=−α(x−xⱼ)+β(y−yⱼ)+γ(z−zⱼ) (2)

In Equation (2), α, β, and γ are constants and xⱼ, yⱼ, and zⱼ are values of the location, size, and direction of the face in the j-th record, respectively. In Equation (2), α, β, and γ indicate degrees of importance of the location, size, and direction, respectively, and can be determined by a user.

Third, the j-th record in which aⱼ is a minimum is found and the found j-th record is determined as being most similar to the recognized information.

Second Method

First, a location value p of a face recognized in an input image and a location value pₖ of a face of the k-th record stored in the composition database 214 are compared with each other, and records in which the distance between the two locations is less than or equal to a preset threshold dₖ (p−pₖ|≦dₖ) are first selected. In this event, dₖ is a constant which can be determined by a user.

Second, records in which the difference between a face size value sₘ of the m-th record among the first selected records and a recognized face size value s is less than or equal to a preset threshold dₛ (|s−sₘ|<dₛ) are secondarily selected. In this event, dₛ is a constant which can be determined by a user.

Third, among the secondarily selected records, a record having a face direction showing a smallest difference from the recognized face direction is thirdly selected and is then determined as being most similar to the recognized information.

In step S140 for configuring a composition area, the crop processing module 230 configures a composition area in an input image according to the found composition information and outputs composition area configuration information to the post processing module 240.

In step S150 for post-processing the composition area, the post processing module 240 modifies the composition area configured by the crop processing module 230 based on location information of the recognized subject, pose information of the recognized subject, etc.

In step S160 for displaying a result of the post-processing, the post processing module 240 crops and outputs an input image according to the modified composition area or outputs an image in which the modified composition area is marked.

FIGS. 8A to 9B are diagrams illustrating image analysis and composition area configuration according to an embodiment of the present invention.

FIG. 8A illustrates a subject image 510 registered in the target database 212, and a contour line 512 of the subject image. In the present embodiment, the subject image 510 corresponds to a first box. The target database 212 stores information on a plurality of feature points within the subject image 510. These feature points are used to match a subject registered in the target database 212 with an image area within an input image. In FIG. 8A, a reference pose 511 of the first box, which is a registered subject, is expressed by a three dimensional Cartesian coordinate system.

FIG. 8B shows an input image 500 obtained by photographing the first box, which is a target to be recognized. The input image includes a table 520, and first to third boxes 530, 540, and 550 placed on the table 520.

Referring to FIG. 9A, the image analysis module 220 recognizes the first box 530 coinciding with the registered subject image based on all or a part of the feature points of the subject image 510 including the contour line 512 of the subject image 510. In this event, the image analysis module 220 detects a contour line 531 and other feature points 532 of the first box 530, determines whether the detected contour line 531 and feature points 532 match with the feature points of the subject image 510, and determines that the first box 530 is identical to the registered subject image 510 when they match with each other. Further, the image analysis module 220 may further detect the pose of the first box.

Although the present embodiment shows, as an example, recognition of an object, a human body or a living thing other than the human body can be recognized in a similar manner. In the case of a 3D subject, a 3D subject image or a 3D subject model may have been registered in the target database 212.

After the recognition of the subject, a crop processing may be performed based on information on the recognized subject.

Referring to FIG. 9B, the crop processing module 230 searches for composition information matching with the recognized subject related information and configures a first composition area 610 in an input image 500 by referring to the composition area included in the found composition information.

For example, when multiple pieces of composition information are found or when the found composition information includes a plurality of composition areas, the crop processing module 230 may automatically select one composition area or display a plurality of composition areas for selection of one composition area by a user.

FIGS. 10A and 10B are diagrams for describing post processing of a composition area according to a first embodiment of the present invention.

In FIG. 10A, a pose 533 of a first box 530 recognized by the image analysis module 220 is expressed by a three dimensional Cartesian coordinate system. In the first composition area 610 configured by the crop processing module 230, the first box 530 is biased to the left side.

Referring to FIG. 10B, the post processing module 240 detects that the pose 533 of the first box 530 is not the frontward pose (i.e. the reference pose 511 shown in FIG. 8A), and can move the first composition area 610 or flip over the left and right of the first composition area 610 (operation 611 as shown by the arrow in FIG. 10B) in a direction opposite to the direction in which the first box 530 is oriented (or in a direction in which the first box 530 is inclined) to modify the first composition area 610 into the second composition area 620. In the present embodiment, the first box 530 is leaning on another object. In this event, it recommendable to modify the first box 530 to include the object on which the first box 530 is leaning.

In contrast, when the recognized subject is a person and the recognized person is oriented in a direction which is not frontward, the composition area may be configured to be biased in the direction in which the person is oriented.

That is, the post processing module 240 may modify the composition area configured by the crop processing module 230 according to the type of the subject and the direction of the subject.

FIGS. 11A and 11B are diagrams for describing post processing of a composition area according to a second embodiment of the present invention.

Referring to FIG. 11A, the image analysis module 220 detects a contour line 531 and other feature points 532 of the first box 530, determines whether the detected contour line 531 and feature points 532 match with the feature points of the subject image 510, and determines that the first box 530 is identical to the registered subject image 510 when they match with each other. Further, without referring to the target database 212, the image analysis module 220 recognizes the second and the third boxes 540 and 550 defined by the edge feature points and the corner feature points in the input image 500. For example, the first box 530 may be recognized by the object recognition engine 420, and the second and third boxes 540 and 550 may be recognized by the line recognition engine 450.

In FIG. 11A, the detected contour lines 541 and 551 of the second and third boxes 540 and 550, respectively, are drawn by thick lines.

The second composition area 620 configured by the crop processing module 230 includes the first and second boxes 530 and 540 but does not include the third box 550. That is, the third box 550 is cut by the second composition area 620.

Referring to FIG. 11B, the post processing module 240 extends the second composition area 620 to include all of the first to third boxes 530, 540, and 550 recognized by the image analysis module 220, to modify the second composition area 620 into a third composition area 630.

FIG. 12 is a diagram for describing a result of post processing according to an embodiment of the present invention.

In a screen of the touch screen 190, the first composition area 610 as shown in FIG. 9B, the second composition area 620 as shown in FIG. 10B, and the third composition area 630 as shown in FIG. 11B are displayed. Further, in a screen of the touch screen 190, a first cropped image 615 according to the first composition area 610, a second cropped image 625 according to the second composition area 620, and a third cropped image 635 according to the third composition area 630 may be displayed. A user may select one of the first to third composition areas 610, 620, and 630 or select one of the first to third cropped images 615, 625, and 635. According to selection by the user, the cropped image may be stored in the storage unit 175.

FIG. 13 is a diagram for describing post processing of a composition area according to a third embodiment of the present invention. The post processing module 240 can reconfigure a second composition area 725, 735, 745, or 755 by moving a first composition area 715 configured by the crop processing module 230 in a direction of line-of-sight according to a pose of a recognized face.

When the line-of-sight of a user is oriented frontward (as shown in box 710), the first composition area 715 configured by the crop processing module 230 is maintained without change by the post processing module 240. When the line-of-sight of a user is oriented upward (as shown in box 720), the first composition area 720 configured by the crop processing module 230 is moved upward to be reconfigured into the second composition area 725. When the line-of-sight of a user is oriented downward (as shown in box 730), the first composition area 715 configured by the crop processing module 230 is moved downward to be reconfigured into the third composition area 735. When the line-of-sight of a user is oriented leftward (as shown in box 740), the first composition area 715 configured by the crop processing module 230 is moved leftward to be reconfigured into the fourth composition area 745. When the line-of-sight of a user is oriented rightward (as shown in box 750), the first composition area 715 configured by the crop processing module 230 is moved rightward to be reconfigured into the fifth composition area 750.

FIGS. 14A and 14B are diagrams for describing post processing of a composition area according to a fourth embodiment of the present invention.

Referring to FIG. 14A, the image analysis module 220 recognizes the first to sixth faces 810, 811, 812, 813, 814, and 815 in an input image 800. The composition database 214 stores composition information relating to a face arrangement of the first and sixth faces 810 and 815, and the crop processing module 230 searches for composition information matching with the information relating to the first and sixth faces 810 and 815, and configures a first composition area 820 in an input image by referring to a composition area included in the found composition information. The second and fourth faces 811 and 813 are cut by the first composition area 820 configured by the crop processing module 230.

Referring to FIG. 14B, the post processing module 240 can extend the first composition area 820 to include all of the first to sixth faces 810, 811, 812, 813, 814, and 815 recognized by the image analysis module 220, to modify the first composition area 820 into a second composition area 830. As an alternate to the present embodiment, when the composition database 214 stores composition information relating to a face arrangement of the first and third faces 810 and 812, the post processing module 240 may reduce the first composition area 820 so as to include the first and third faces 810 and 812 recognized by the image analysis module 220 while preventing another recognized face 811, 813, 814 and 815 from being cut.

According to the present invention, a composition area is automatically configured using information on a composition of a subject, so as to achieve a more exact image cropping. Further, according to the present invention, a composition area is configured through matching using a database, so as to achieve a faster image cropping in comparison with the prior art.

Although the touch screen has been illustrated as a representative example of the display unit displaying the screen in the above-described embodiments, a general display unit, such as a Liquid Crystal Display (LCD), an Organic Light Emitting Diode (OLED), and a Light Emitting Diode (LED), which do not have a touch detection function may also be used instead of the touch screen.

It may be appreciated that the embodiments of the present invention may be implemented in software, hardware, or a combination thereof. Any such software may be stored, for example, in a volatile or non-volatile storage device such as a ROM, a memory such as a RAM, a memory chip, a memory device, or a memory IC, or a recordable optical or magnetic medium such as a CD, a DVD, a magnetic disk, or a magnetic tape, regardless of its ability to be erased or its ability to be re-recorded. It can be also appreciated that the memory included in the portable terminal is one example of machine-readable devices suitable for storing a program including instructions that are executed by a processor device to thereby implement embodiments of the present invention. Accordingly, the present invention includes a program that includes a code for implementing an apparatus or a method defined in any claim in the present specification and a machine-readable storage medium that stores such a program. Further, the program may be electronically transferred by any communication signal through a wired or wireless connection, and the present invention appropriately includes equivalents of the program.

Further, the terminal can receive the program from a program providing apparatus connected to the device wirelessly or through a wire and store the received program. The program providing apparatus may include a memory for storing a program containing instructions for allowing the portable terminal to perform a preset image editing method and information required for the image editing method, a communication unit for performing wired or wireless communication with the portable terminal, and a controller for transmitting the corresponding program to the portable terminal according to a request of the portable terminal or automatically.

Although embodiments are described in the above description of the present invention, various modifications can be made without departing from the scope of the present invention. Accordingly, the scope of the present invention shall not be determined by the above-described embodiments, and is to be determined by the following claims and their equivalents.

What is claimed is:

1. An image editing method comprising:
recognizing a subject in an input image and extracting information related to the recognized subject;
identifying composition information corresponding to the extracted subject-related information in a composition database;
configuring a composition area in the input image according to the identified composition information; and
displaying an image corresponding to the composition area on a screen.

2. The image editing method of claim 1, wherein the extracted subject-related information comprises information relating to one or more of a type, a location, a size, and a pose of the subject.

3. The image editing method of claim 1, further comprising:
cropping the input image according to the composition area; and
storing the cropped image.

4. The image editing method of claim 1, wherein configuring the composition area comprises modifying the configured composition area based on the extracted subject-related information.

5. The image editing method of claim 4, wherein modifying the configured composition area comprises:
determining whether another subject not included in the configured composition area exists in the input image; and
modifying the configured composition area to include the recognized subject and the another subject.

6. The image editing method of claim 4, wherein modifying the configured composition area comprises:
determining a pose of the recognized subject; and
extending or moving the configured composition area based on the determined pose of the recognized subject.

7. The image editing method of claim 1, wherein identifying the composition information comprises:
comparing the extracted subject-related information with records stored in the composition database; and
detecting a record matching with the extracted subject-related information among the records.

8. The image editing method of claim 7, wherein each of the records comprises information on one or more of a resolution of an image, an aspect ratio of an image, a size of an image, an intensity of a subject, a type of a subject, a location of a subject, a size of a subject, and a pose of a subject.

9. The image editing method of claim 8, wherein each of the records further comprises information on one or more of a location of a composition area and a size of a composition area.

10. The image editing method of claim 1, wherein the subject is one of a saliency, an object, a body, a face, and a line.

11. The image editing method of claim 1, wherein configuring the composition area comprises:
displaying a plurality of composition areas according to the identified composition information for a user; and
configuring a composition area in the input image according to a composition area selected by the user.

12. A terminal providing an image editing function, the terminal comprising:
a display unit configured to display a screen;
a storage unit configured to store a composition database; and
a controller configured to recognize a subject in an input image, extract information related to the recognized subject, identify composition information corresponding to the extracted subject-related information in a composition database, configure a composition area in the input image according to the identified composition information, and display an image corresponding to the composition area on a screen.

13. The terminal of claim 12, wherein the extracted subject-related information comprises information relating to one or more of a type, a location, a size, and a pose of the subject.

14. The terminal of claim 12, wherein the controller is further configured to crop the input image according to the composition area, and store the cropped image.

15. The terminal of claim 12, wherein the controller is further configured to modify the configured composition area based on the extracted subject-related information.

16. The terminal of claim 15, wherein the controller is further configured to determine whether another subject not included in the configured composition area exists in the input image, and modify the configured composition area to include the recognized subject and the another subject.

17. The terminal of claim 15, wherein the controller is further configured to determine a pose of the recognized subject, and extend or move the configured composition area based on the determined pose of the recognized subject.

18. The terminal of claim 12, wherein the controller is further configured to compare the extracted subject-related information with records stored in the composition database, and detect a record matching with the extracted subject-related information among the records.

19. The terminal of claim 18, wherein each of the records comprises information on one or more of a resolution of an image, an aspect ratio of an image, a size of an image, an intensity of a subject, a type of a subject, a location of a subject, a size of a subject, and a pose of a subject.

20. The terminal of claim 19, wherein each of the records further comprises information on one or more of a location of a composition area and a size of a composition area.

21. The terminal of claim 12, wherein the controller is further configured to display a plurality of composition areas according to the identified composition information for a user; and configure a composition area in the input image according to a composition area selected by the user.

22. A non-transitory machine-readable recording medium having recorded thereon a program for executing an image editing method, the method comprising:
recognizing a subject in an input image and extracting information related to the recognized subject;
identifying composition information corresponding to the extracted subject-related information in a composition database;
configuring a composition area in the input image according to the identified composition information; and
displaying an image corresponding to the composition area on a screen.
